(19) United States
(12) Patent Application Publication
(10) Pub. No.: US 2002/0194492 A1
(43) Pub. Date: Dec. 19, 2002

(54) Method of protecting and managing digital contents and system for using thereof

(76) Inventors: Jong-Uk Choi, Seoul (KR); Jong-Won Kim, Seoul (KR); Nam-Yong Lee, Seoul (KR); Won-Ha Lee, Seoul (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/136,584

(22) Filed: Apr. 30, 2002

(30) Foreign Application Priority Data
Apr. 30, 2001 (KR) 2001-23562

(51) Int. Cl. H04L 9/00

(52) U.S. Cl. 713/200

(57) ABSTRACT

A method and system for protecting copyright of digital contents and contents themselves which are distributed. A user receives the encrypted digital contents and encrypted decryption key capable of decrypting the encrypted digital contents. A key is generated from the system information representing a user personal unique system characteristic and the encrypted contents decryption key is decrypted. Decrypting the encrypted contents decryption key is proceeded only when a key generated by extracting information of a personal system of the contents to be used by a user is identical to a decryption key of the encrypted contents decryption key. When the contents decryption key is decrypted, the encrypted contents are decrypted and generated using the above decrypted contents decryption key.

Such method approves only play/use of contents in the corresponding system, thereby preventing contents from being illegally used and distributed.

### BACKGROUND OF THE INVENTION

This application claims priority to Korean patent application number 2001-23562, titled METHOD OF PROTECTING AND MANAGING DIGITAL CONTENTS AND SYSTEM FOR USING THEREOF, filed on Apr. 30, 2001, and is incorporated by reference hereto.

1. Technical Field

The present invention relates to a method of protecting, securing, and managing digital contents and system for using the same, more particularly to a method of protecting, securing, and managing digital contents which are provided on-line and a system for using the same by using the characteristic of a user system.

2. Description of the Related Art

Lately development of Internet and digitalization of a variety of contents give us opportunity to more easily obtain the material as desired. Meanwhile, easy copying and distribution accelerate small-scalization of contents provider and manufacturer and thus request for a technology of protecting contents goes on rapidly increasing. Hence, the digital rights management (hereinafter referred to as DRM) technology for protecting, securing, and managing digital contents has been developed. In other words, a technology of preventing distributed digital contents from illegally being used and continuously protecting and managing rights and benefit of copyright holders and license holders which are generated by using the protected contents, and technology of serving digital contents have been developed.

For the protection and service of digital contents, DRM technology, digital watermarking, digital object identifier (DOI), and INDECS (Interoperability of Data in E-Commerce System), etc. as a technology of protecting digital copyright provide a related technology and solution.

First, the digital watermarking, which is widely used for copyright certification, is a technology of embedding information related to copyright in the contents to protect copyright. However, the conventional digital watermarking has disadvantage that a copying of or distribution of contents by intercepting the contents when using the contents in a computer or other portable device (PD) makes it impossible to protect the contents.

Therefore, a technology is required to satisfy the request of contents providers and manufacturers that want their ownership and copyright for digital contents to be protected more perfectly. At present the digital watermarking is employed for not previously preventing contents from being copied or distributed but “post-certifying” ownership or copyright of contents illegally copied or distributed.

The recently appeared DRM is a technology of protecting copyright of digital contents and controlling and managing distribution and use of copyright and contents. To be more specific, it prevents multimedia contents from illegally distributed and copied and helps only a legal user using contents, and simultaneously managing copyright of multimedia contents through a user management and billing service, etc. The function of DRM is largely classified into protection of digital contents, management of the usage rules, and management of payment system. Companies having the DRM technology have developed technologies by utilizing different methods, respectively.

By such DRM technology, digital contents are protected through an encryption process so as to prevent the illegal distribution and use of the digital contents throughout the entire processes of generation, distribution, use, and disuse. DRM allows only a legal user having an encryption key to decrypt the encrypted contents, thereby using the contents. Even if the contents are illegally distributed, it is impossible to use the contents without a key, which results in protecting the contents.

The most important thing in DRM is a technology for encrypting contents, which usually uses a 128 bit encryption and could be a core technology for preventing an illegal use. Stability and security of encryption technology of DRM make protection and management of copyright of contents easy. A technology developed by Intertrust in USA could be most widely used in the DRM technology area at present.

DRM is considered as a very realistic solution for protecting and managing copyright of digital contents in the present market. However, it is not easy for a contents service provider to apply DRM and perform its service since DRM systems now developed and commonly used are too complicated and huge.

When general users really buy contents to play or use the contents, it is common that a DRM server provider completely operates a management problem of the used authentication key, and that contents are registered and operated in the DRM server provider. Hence, a contents provider (CP) has some cumbersome things in terms of a system building and management of contents. As to DRM, in case where an encryption of the contents is decrypted, it is concerned that source contents could be easily distributed.

Therefore, it is an object of the present invention to provide an integrated method and system for protecting and managing contents in order to solve the problem of a contents protection system.

It is other object of the present invention to provide a method of protecting contents and system for using the same by employing an personal unique system characteristic for protection of contents.

It is another object of the present invention to provide a contents management system (hereinafter referred to as “CMS”) through a browser and hardware controller, which suggests a method of protecting and managing copyright more perfectly and prevents contents from illegally being used, by preparing primary protection of contents based on the watermarking technique and system for authenticating and certifying copyright of contents and by managing and distributing primarily protected contents securely.

### SUMMARY OF THE INVENTION

According to one aspect of the present invention, a method of protecting digital contents comprising the steps of (a) receiving the encrypted decryption key and encrypted digital contents; (b) decrypting said encrypted decryption key with a key generated from system information which represents personal unique system characteristic that a user uses; (c) decrypting said encrypted digital contents by using the decrypted key in case where a key is decrypted in said step of decrypting a key; and (d) using said decrypted contents is provided.

Further, according to other aspect of the present invention, a system for protecting and managing contents comprising a digital contents managing means for establishing and managing digital contents as a database; a user unique key generating means for generating a user unique key generated using a system unique information of a user system which receives said digital contents through a transmission; an encryption key generating means for generating a digital contents encryption key for encrypting said digital contents in response to said transmission request of a user system; a key managing means for storing and managing said user unique key and said contents encryption key; a contents encryption means for encrypting said digital contents to be transmitted, using said contents encryption key in said key managing means; a decryption key encrypting means for encrypting said contents encryption key (decryption key) with said user unique key; a contents providing means for transmitting said digital contents encrypted by said contents encrypting means to said user system by controlling said key managing means in accordance with said transmission request of user system is provided.

The present invention characterized as described above is basically to suggest a method of and a system for protecting and managing contents through the entire processes of generation, distribution and disuse of a copyrighted work, that is, from the instant that digital contents are generated, i.e., the instant that digital contents are produced and come to be of value as a copyrighted work through the process the work is distributed through a network or an off-line path, such that it is used by a variety of users, to the instant that the work is disused.

The present invention suggests the entire management system so as not to use by stealth, forge, and alter digital contents without permission by granting users right to use digital contents in a lawful way while protecting copyright of digital contents in the process of distributing digital contents.

### BRIEF DESCRIPTION OF THE DRAWINGS

FIG. 1 is a block diagram illustrating the overall relation of purchase and distribution of digital contents by a integrated contents protection system according to the present invention.

FIG. 2 is a schematic block diagram illustrating the architecture of a system for protecting and managing digital contents according to the present invention.

FIG. 3 is a schematic block diagram illustrating the operation related to a primary key generation and management in the system according to the present invention referring to FIG. 2.

FIG. 4 is a schematic block diagram illustrating the operation of downloading and using digital contents by a user in the system according to the present invention referring to FIG. 2.

FIG. 5 shows an example of a player of playing an audio file, an example of digital contents.

FIG. 6 is a flow chart illustrating the processing of the contents that CD side supplies.

FIG. 7 is a flow chart illustrating a series of processes of downloading contents by a user in view of CC side.

FIG. 8 is a flow chart illustrating a process of generating a user unique key (CC_UUID) from the system information of a user.

FIG. 9 is a flow chart illustrating a series of processes performed for managing digital contents in view of CD side.

FIG. 10 is a flow chart illustrating a process of using digital contents that CD side supplies using a unique key in view of CC side.

FIG. 11 is a flow chart illustrating a series of processes of the operation of a function controlling portion related to contents operation provided by the present invention.

Hereinafter a method of protecting and managing digital contents and system of using the same according to the present invention referring to the figures attached are explained more specifically.

### DETAILED DESCRIPTION OF THE PREFERRED EMBODIMENTS

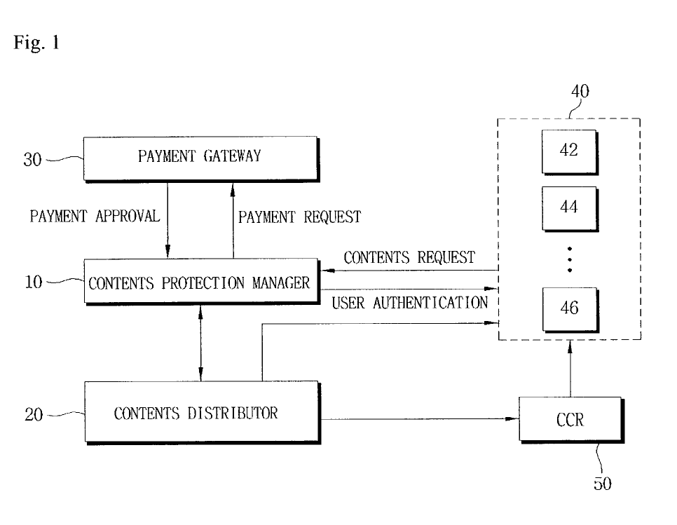

FIG. 1 is a block diagram illustrating the overall interrelation of purchase and distribution of digital contents by a integrated contents protection system according to the present invention. In FIG. 1, 10 indicates a contents protection manager (hereinafter, referred to as CPM) for managing contents, 20 a contents provider (hereinafter, referred to as CP) or contents distributor (hereinafter, referred to as CD) for providing contents using said service, 30 a payment gateway for processing a payment request and performing a payment related process like a payment approval, 40 a contents consumer (CC; i.e., a user system) for buying contents, 50 a contents controller (hereinafter, referred to as CCR) for controlling functions (e.g. message hooking or clipboard deletion) related to protection of contents functionally on browser and a terminal employed in a user system.

In the above system, the present invention does not divide the contents provider 20 into CD and CP, and calls it collectively as CD in combination of the functions. Hereinafter a series of incidents occurred to CD 20 side is what occurs to the contents distributor side. The contents distributor could be a contents manufacturer, and a contents provider holding license of contents.

CD 20 experiences a predetermined process for giving a right to use its own digital contents only to a user who paid for digital contents as an authenticated consumer (user). For above process, if CC 40 side makes a contents request to CPM 10, CD 20 performs service having, in CPM 10, a key management server (KMS) for a user authentication and contents encryption which will be later described in detail or performs service having a key management server in its own side while managing a key.

FIG. 1 is explained by exemplifying a state where the above role is separated. First, CD 20 encrypts its own contents. And CPM 10 manages a user key comprising a user information and an encryption key that is used to encrypt contents. CC 40 reads digital contents provided by CD 20 on Web through Internet or through an off-line path. At this time, CD 20 installs CCR 50 for performing a function to prevent digital contents from being illegally used on a homepage of the Web so that a user can read only contents and can not store or copy them illegally for use. CC 20 basically experiences a membership registration process and user authentication process for consuming digital contents from CD 20.

Regarding the payment for use of digital contents occurred in the above process, CPM 10 connects to the payment gateway 30 so that it provides CC 40 with a variety of available payment conditions, and transmits the payment conditions to the payment gateway 30. The payment gateway 30 inspects the payment condition to transmit a signal that the payment is approved to CPM 10 in case where the condition falls under the condition to be lawfully paid in accordance with the corresponding condition. A billing list, a payment-related item made in the above manner, is transmitted to CD 20 in real time or in a regular interval.

If authentication for a consumer, CC 40 regarding the contents request of CC 40 including payment for using digital contents as above is made in CPM 10 through the contents protection manager 10 and payment gateway 30, contents provided by CD 20 can be received by such process as download. A user A 42 who buys digital contents primarily goes through a user authentication and receives a key capable of decrypting the contents to decrypt the contents and thus plays/uses the contents.

In case where user A 42 distributes contents which a user A bought to a second and third user B 44 or user C 46 who do not buy contents, it is possible to transmit the encrypted contents bought by user A 42. However, it is impossible for user B 44 or user C 46 to decrypt contents and play/use them. Using digital contents will be in detail explained later. Hence, in case where user B 44 and user C 46 want to use the corresponding digital contents, they should connect to service to receive a user authentication along with a user registration and obtain a right to use contents through a series of processes, in the same manner that user A 42 did.

For reference, as described above, the function of CCR 50 is to prevent illegal users from using illegally or by stealth said contents when CD 20 uploads various lists and sample contents for a reading of contents that can be bought and used by a user using an Internet homepage. In reading contents provided by CD 20, users cannot store or copy them illegally. When users virtually buy contents, the contents protected by CPM 10 could be transferred to CC 40. Such detailed function of CCR 50 will be later explained.

The basic function of CPM 10 is to protect contents through an encryption process and manage and thereby protect copyright of contents, in order to prevent contents from being illegally distributed and used throughout the entire process of generation, use, distribution, and disuse of digital contents. Only a legal user having an encryption key can decrypt the encrypted contents to use them, and even if contents are illegally distributed, the contents cannot be used without a key, thereby protecting contents. In particular, the present invention bolsters security in transmitting a key of decrypting the encrypted contents to a user and thus preventing a key drain, which will be later explained.

CC 40 uses a key only when contents are used, which always remain encrypted and locked and are provided in an available form using a key only during use. At this time, the form as provided can use a format of a streaming. CD 20 side or CPM 10 side can establish rules related to contents use in the above contents distribution and distribution system. The above rules represent a usage rule and right of each personal when distributing and using contents, and are not directly related with copyright protection of digital contents. The rules make it possible to provide effective contents through a free rule management such as addition or revision of rule according to the redistribution of digital contents. It is surely possible for users to use contents only by the approved rules.

Next, the management part of payment system, which is not directly related to copyright protection of contents, performs functions of managing the use item of digital contents and managing payment and approval based on the use item, since the ultimate purpose of copyright protection is for a profitable business of CD 20. It can be designed to have two optional modules for integrated between authentication and payment system that is pay-per-view or etc. according to a user authentication.

The function of CPM 10 in the system by the medium of the above digital contents is more concretely explained referring to the drawings appended hereto.

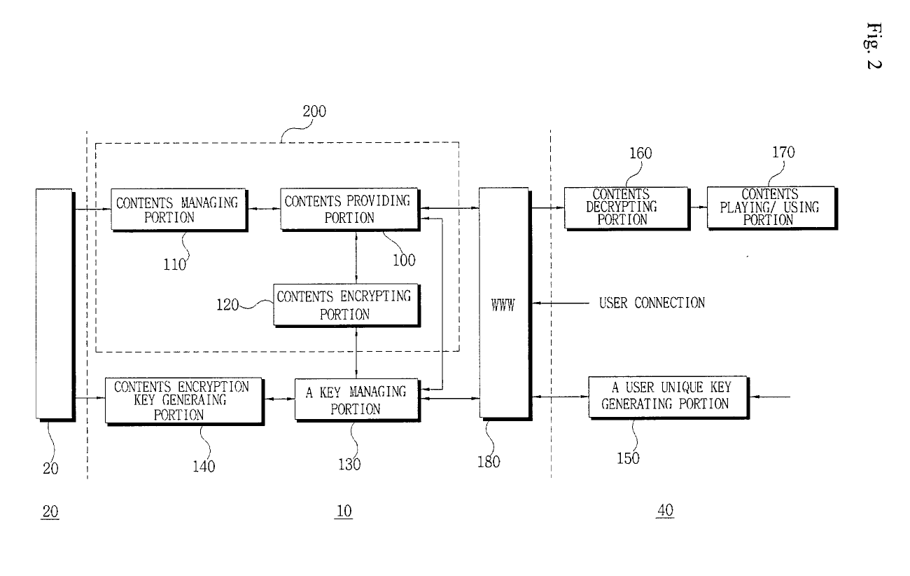

FIG. 2 is a schematic block diagram illustrating the architecture of a system for protecting and managing digital contents according to the present invention. As shown in FIG. 2, CPM 10 includes a contents providing portion 100 for providing the corresponding digital contents in accordance with a contents transmission request for a person requesting the contents service, a contents managing portion 110 for building a database for the digital contents which is provided and processed from CD 20 and managing the database, a contents encrypting portion 120 for performing encryption to be included in digital contents which will be provided for CC 40, a key managing portion 130 for storing and managing an contents encryption key and a unique key for a system characteristic of CC 40, and a contents encryption key generating portion 140 for generating an encryption key for encrypting the contents provided from CD 20.

In the above components, the contents providing portion 100, contents managing portion 110, and contents encrypting portion 120 manage, encrypt, and process the contents provided from CD 20, which architects a CD controlling portion 200.

CC 40, in addition to the basic components of a user system, include a user unique key generating portion 150 for generating a user unique key in accordance with information of the unique characteristic from the system information in CC 40, a contents decrypting portion 160 for decrypting digital contents to be provided to CC 40, and a contents playing/using portion 170 for playing/using the decrypted digital contents. In the above components, the user unique key generating portion 150 is included in CC 40; however, it does not matter even if it is included in CPM 10.

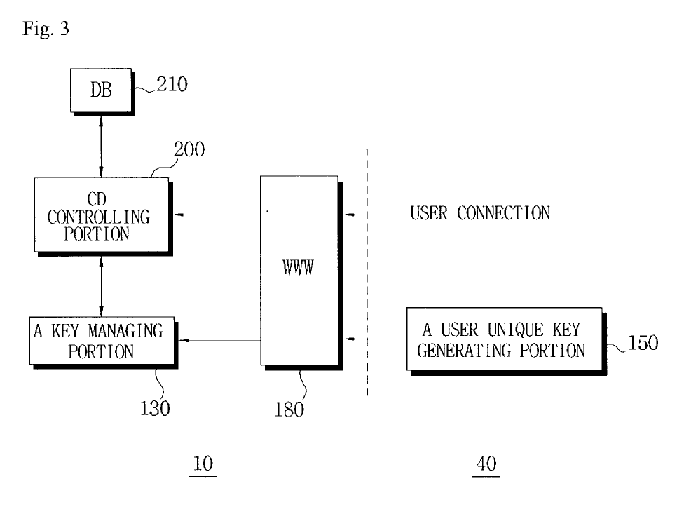

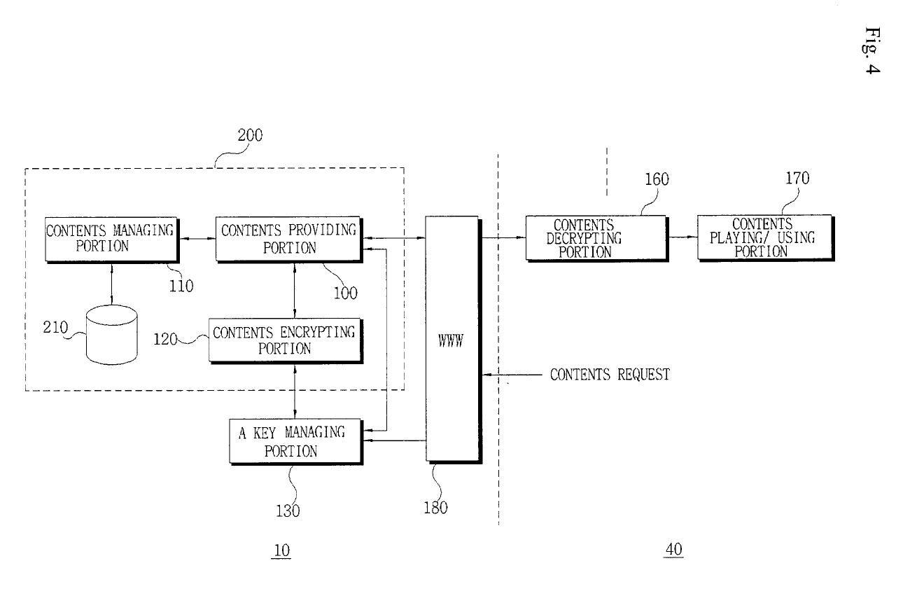

The above architecture shows the overall relation of CPM 10, CC 40, and CD 20. The flow of the operation relating to a primary key generation and management is reviewed referring to FIG. 3 and provision of contents for CC 40 is reviewed referring to FIG. 4. FIGS. 3 and 4 show only the components relating to the operation mentioned below.

First, a key generation and management is reviewed referring to FIG. 3. Regarding the key generation, in case where CC 40 does not register the service provided by the present system, a process of user registration performed in CD controlling portion 200 through a web server 180 is experienced. The registered user information, i.e., the data such as a personal data or payment means of a user is separately stored and managed in the database 210. The detailed procedure of the above user registration is omitted since it is similar to a general user registration already used on Internet.

Simultaneously with a user registration, an application (like Active X) for generating a user unique key (CC_UUID) is downloaded to a user system of the user CC 40 and automatically executed, whereby automatically extracting the system information corresponding to the system unique characteristic of CC 40 side and transmitting it to the user unique key generating portion 150 for generating a user unique key. At this time, the user unique key means a unique information of system, for example, the unique key of a user which is generated using system unique characteristics such as an ID of a processor or ID of hard disk.

The user unique key generated such as above is transferred to a key managing portion 130 of managing a user unique key and contents encryption key through the web server 180 and is managed as information for users who use the system according to the present invention. The key managing portion 130 manages information regarding the encryption key generated for encryption for digital contents provided to users along with a user unique key. Further, in case where the user unique key generating portion 150 is formed inside CPM 10, only a system information corresponding to the system unique characteristic is extracted in the user system, is transferred to the user unique key generating portion 150, for generating a user unique key by way of the web server 180, and thus is transferred to the key managing portion 130.

Further, an exclusive viewer capable of listening to and watching digital contents to be provided from CD 20 is downloaded to CC 40 side during a user registration process, thereby enabling to use service of using the corresponding contents.

FIG. 4 shows a case that CC 40 requests digital contents for CPM 10 and uses them. As shown in FIG. 4, after connecting to web service (home page) which provides service according to the present invention through the web server 180 and going through a process of user authentication, CC 40 selects one of digital contents of the contents managing portion 10, which includes information regarding digital contents to be bought, and requests its transmission.

In response to such request, the contents providing portion 100 receives digital contents which is stored in the database 210 through a contents managing portion 110. Further, if the contents providing portion 100 requests a key for encrypting contents from the key managing portion 130, the key managing portion 130 transfers an encryption key generated by the contents encryption key generating portion 120 to the contents encrypting portion 120 of CD controlling portion 200. CD controlling portion 200 encrypts the corresponding digital contents using such encryption key. CD controlling portion 200 encrypts a decryption key capable of decrypting the encrypted information with the user unique key (CC_UUID) and provides it to CC 40 by way of the web server 180 along with the encrypted contents.

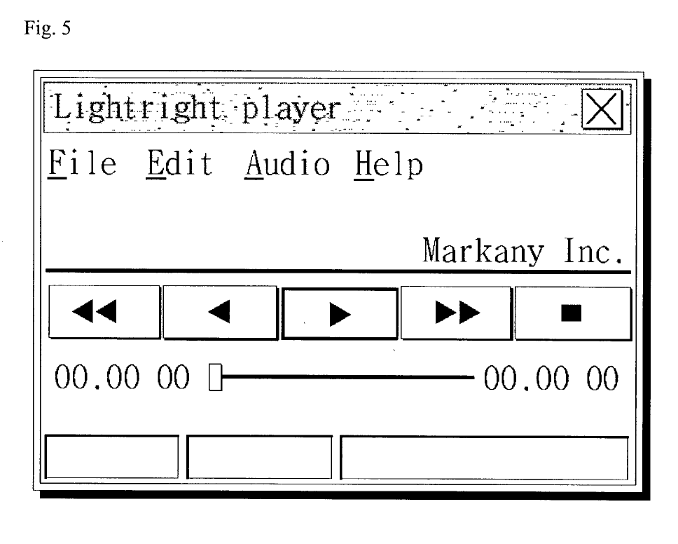

After downloading the encrypted digital contents from CD controlling portion 200, if an exclusive viewer provided by CD 20 is executed, CC 40 decrypts the encrypted digital contents by the contents decrypting portion 160 and the decrypted contents can be used using the contents playing/using portion 170. A process of using digital contents will be later explained. The exclusive viewer shown in FIG. 5 illustrates an example of a player for playing an audio file as downloaded for an example of an audio file.

The operation of each component in the system for protecting and managing digital contents according to the present invention having the architecture and function described above will be more clearly reviewed hereinbelow.

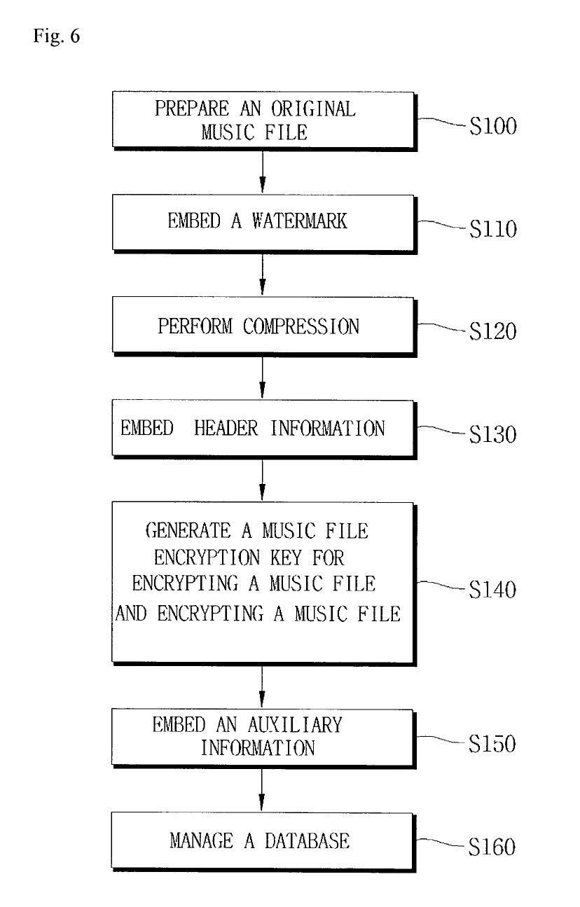

A procedure of processing digital contents basically provided in CD is reviewed referring to FIG. 6. The process shown in FIG. 6 illustrates a series of procedure of processing the contents that CD holds. The process of contents provided by CD may be made when a user system requests particular contents or when contents previously provided by CD is processed in a predetermined form and stored in a predetermined database. The process shown in FIG. 6 illustrates the latter.

Digital contents include a variety of files as well as a multimedia file including image, audio, and moving picture. By way of an example, a music file will be explained hereinbelow.

First, the original music file that CD holds is prepared (Step S100). A watermark is embedded into the original music file to be converted (Step S110). Intellectual Rights Information (IRI) is embedded as a robust watermarking method for a post-tracking of an illegal duplication of a music file. Then, Trigger Bits (TRIG) based on a method that is requested from the technology selected as a standardization technology is embedded. A process of embedding a watermark may be omitted by a request of CD.

For reference, a Trigger is a special form of the stored procedure automatically executed when trying to correct data protected by a table. The Trigger Bits are bits which act on a series of signals and execute a particular step when there is an external stimulus such as compression of contents.

After embedding a watermark, compression for the corresponding music file is performed (Step S120). Since the digitalized music file itself is considerably large and thus there is a problem in transmitting the form as it is, it is compressed to be a size suitable to on-line trade. The compression method uses a general audio file format such as mp3 or AAC. A file format provided in CPM service in the present invention is designated in this step. The present invention explains mp3 as an example regarding a music file but, various compression methods may be used according to request of CD and kinds of contents files.

After compression of a music file, the header information is attached to the corresponding file (Step S130). The attached header includes information of right to use such as a copy control information (CCI), maximum copy number (MCN), intellectual rights information, music ID, etc., which specifically have the following values.

CCI: consists of 2 bits and represents information of 4 different bit combination, “Copy Free” (CCI=00), “Copy One Generation” (01), “Copy No More” (10), and “Copy Never” (11). “Copy No More” falls under the case where “Copy One Generation” goes beyond the restricted copy scope and “Copy Never” is the case where the original music itself is restricted.

If 00, 01, 10, 11 designated herein are provided in the order of 00, 01, 11, 10, it can be more comfortably changed by the basic principle of Gray Code. (For reference, since Gray Code has a characteristic that only one bit of front and rear code is changed, it has an important characteristic capable of finding an error of material in the system receiving analog data having a consecutive characteristic, thereby having been largely used. It is a non-weighted code and used in an A/D converter (analog-to-digital converter).)

MCI: is valid only in case of “Copy One Generation” and assigned to about 4 bit.

IRI: is the copyright information, whose allowed bits can be decided on request. The embedded copyright information can be determined in combination of title of a music file or name of a singer or a license holder, etc.

Music ID: indicates ID for music files.

Random bits as a pad is added to the header including the above information, which results in 128 bits (i.e., header bits+random bits=128 bits), and thus the header is concealed.

After the header information is embedded, an encryption key for a music file is generated and simultaneously the music file is encrypted (Step S140). A music file encryption key (CD_UUID) is generated having a byte length of a predetermined size, 128 bit length in the present invention, and the generated music file encryption key (CD_UUID) is managed in the key managing portion 130.

When an encryption key is generated, the encrypted music file (Encrypted_music) is made using a music file compressed in the Step S120, a header information embedded in the Step S130, and a music file encryption key (CD_UUID). An encryption is proceeded with 128 bit key (CD_UUID) made by CD wherein a variety of encryption algorithms widely used can be used. In the present invention, encryption is proceeded with Twofish Encryption algorithm or Blowfish Encryption algorithm as an example.

When the encryption operation is finished, auxiliary information is added to the encrypted music file (Step S150). The auxiliary information for a music file is determined by a general information (name of a recording company, name of a singer, publication date, etc.) relating to music. The auxiliary information (AuxInfo) such as information on the mp3 compression, information on the duplication, information on the present music format is added. The auxiliary information makes a random bits as much as keylength byte and then writes auxiliary information about the music as a plain text.

When the auxiliary information is inputted, the processing of a music file itself is basically finished. Said music file is stored in the database 210 and then managed (Step S160). CD controlling portion 200 manages, as a database, the original music, the encrypted music, preview music, and key which is used in the encryption.

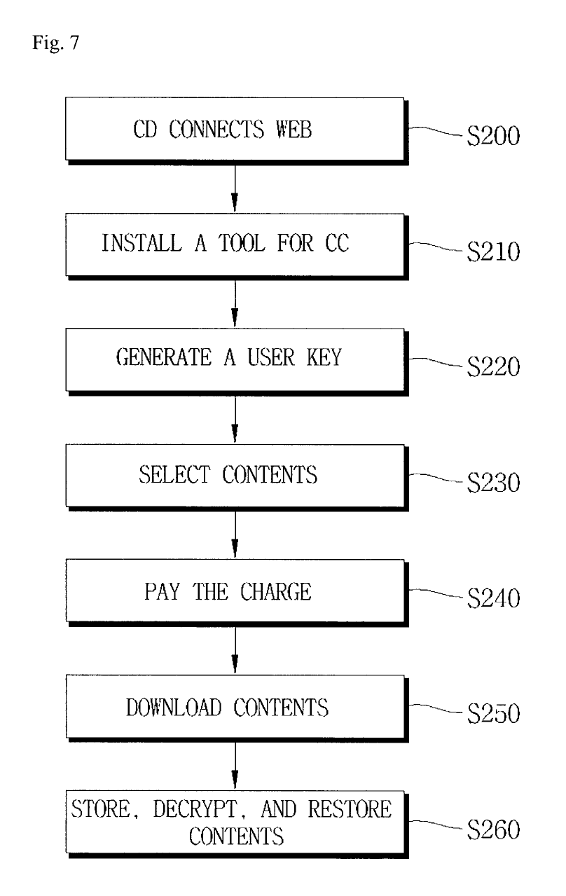

A series of process of downloading digital contents generated above at the user CC side is reviewed referring to FIG. 7.

First, CC 40 connects to the web service (homepage) over the web server 180 provided by CD and performs a basic registration procedure provided by CD (Step S200). After successfully performing a registration procedure, a program for CC 40 is downloaded and installed (Step S210). At this time, installation of a program is executed automatically or manually by the selection of a user. At this time, an exclusive viewer for using contents can be downloaded.

A personal unique key (system ID), i.e., CC_UUID is generated in consideration of the system characteristic of CC 40 by executing a program installed after being downloaded in the terminal (such as PC, etc.) of a client (Step S220). At this time, a personal unique key is automatically generated, CC 40 selects contents as desired among digital contents provided by CD 20 (Step S230) and pays the charge using an payment means (Step S240). If CC 40 pays the charge, as mentioned above, the corresponding digital contents are downloaded to the region of CC 40 after a confirmation procedure of the payment gateway 30 (Step S250). If downloaded, the digital contents are generated through a decryption process of the corresponding contents using a program tool in CC 40 (Step S260).

In particular, programs on client to be installed in CC 40 could be ones for a kind of generation which must be installed on a terminal such as a consumer's computer so that a contents consumer buys contents which are protected and managed by CPM 10 and generates them through a terminal such as his/her own computer. These programs include a system encryption function which is called a SysCrypt and is expressed as a mark E(*). The system encryption function (SysCrypt) is equally operated in the programs for CC 40 or CD 20 installed in all the personal computers. The program for CC 40 generates a system unique encryption key (or ID, CC_UUID) from the unique hardware information (CPU ID or serial number of hard disk, model information, manufacturing company information, etc.) of a personal computer when installed.

The installed programs for CC generates or extracts a user unique key (CC_UUID) from the hardware information of a personal computer every use of digital contents and discontinues use when the generated or extracted value is different from the existing CC_UUID, which prevents programs for CC from being executed in other PC. When installing programs for CC, a public key and private key of 1024 bits are randomly generated. Each key is encrypted by the system encryption function (SysCrypt) and is stored in the programs for CC and thus it is impossible for CC 40 to directly access to the virtual value. All the music played in the programs for CC are managed as a database (DB), which is encrypted by the system encryption function (SysCrypt) and thus the contents can be accessed only by a key manager.

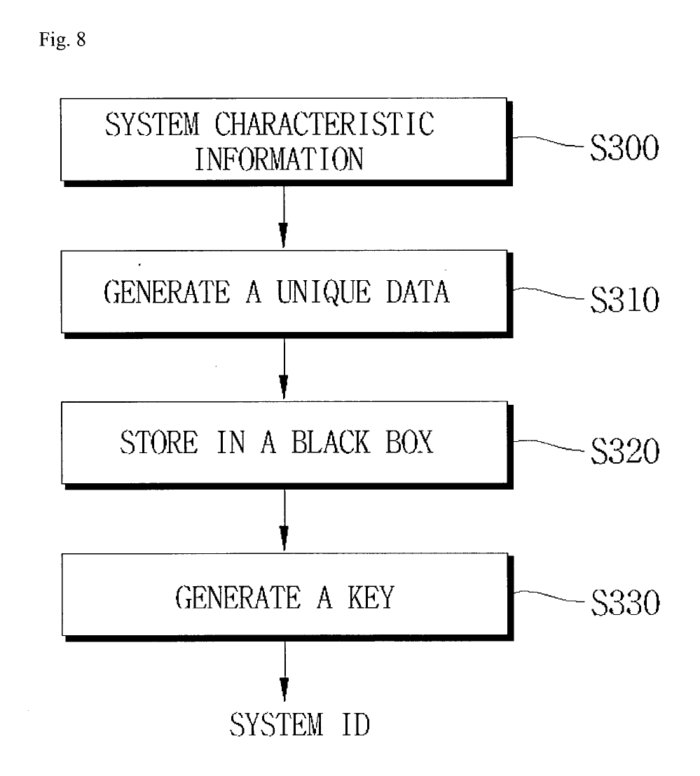

The concept and the generating process of the above user unique key is explained referring to FIG. 8.

CC_UUID formed by the user unique key generating portion 150 through a user registration is managed in the key managing portion (130). Also, a key (CD_UUID) of encrypting contents is generated in the contents encryption key generating portion 140 of CPM 10. The key may be differentiated by contents in accordance with a key policy and may be differently generated in accordance with contents manufacturers or contents category. The generated CD_UUID is also managed by the key managing portion 130 and simultaneously database is generated and thus contents are managed. The above key generation and management may be operated separately from or in combination of CD.

A process of generating the system unique ID (CC_UUID) of a user is more specifically explained hereinbelow.

Elements of architecting a computer system are a central processing unit (CPU), RAM, hard disk (HDD), and various devices. The contents using control by the system unique ID (CC_UUID) suggested in the present invention means controlling whether to use/play contents with a system unique ID of each user.

First, CPU has a unique ID in the chip over Pentium III and RAM, a memory, has no unique ID. Also, a manufacturing company information (IDE) can be found by investigating a physical sector of the master region of the HDD. The manufacturing company information includes a manufacturing company name, serial number, model, etc. Regarding the serial number, a number used in manufacturing companies A, B, etc. may be redundantly overlapped. Such information representing system characteristics are extracted (Step S300). A unique data is generated based on the above extracted system information (Step S310).

After storing the unique data in the known black box of which function cuts off the unique data so as not to be confirmed outside (Step S320), the system unique ID, i.e., CC_UUID suggested in the present invention using such unique data is generated (Step S330). Algorithm for generating the system unique ID may be realized by a variety of methods. The generated CC_UUID should not be remained in the registry for the maintenance of confidentiality, and ID is searched/generated and the encrypted contents are decrypted every time of using contents in a plug-in application form provided in the present invention. The plug-in is sure to be built in the black box. The contents that a particular CC buys by CC_UUID generated by the above series of processes are controlled so as not to be redistributed to a second, third user and reused without a certified approval.

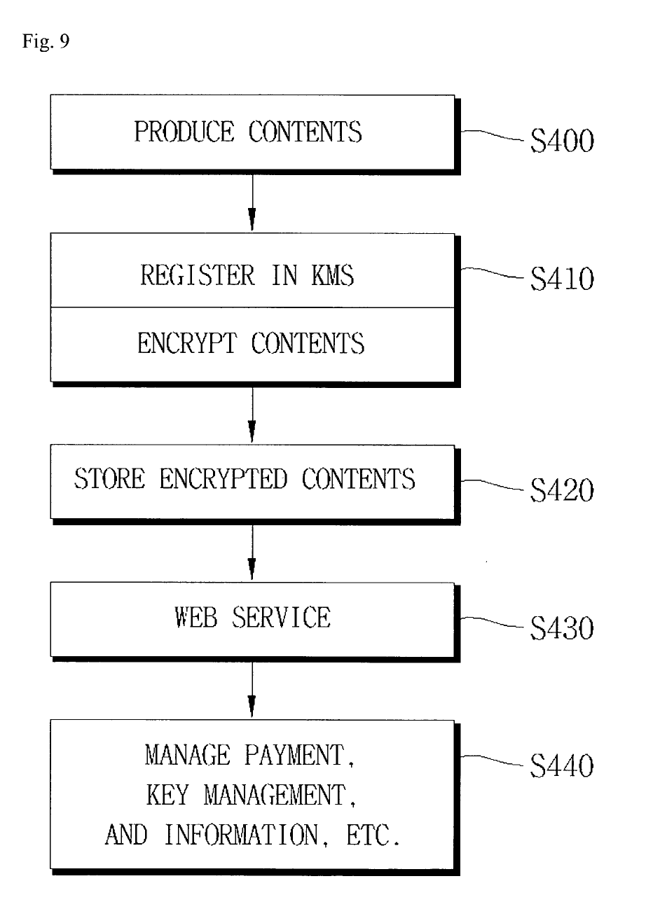

Next, a series of processes performed at CD side are reviewed referring to the flow of FIG. 9. First, CD 20 basically manufactures digital contents to be provided for CC 40 side (Step S400). CD directly may manufacture digital contents but other digital contents may be provided from the outside. When digital contents are prepared, their information is registered to the contents database (210) of the contents managing portion 110 and a process of contents encryption is performed (Step S410). The digital contents provided in CD 20 are transferred to the contents providing portion 100 through the contents managing portion 110 and a key for encrypting these digital contents is transferred to the contents encrypting portion 120 through the contents encryption key generating portion 140 and a key managing portion 130. After the contents encrypting portion 120 encrypts the corresponding digital contents, such is transferred to the contents managing portion 110 through the contents providing portion 100. The above encrypted digital contents is stored and managed in the database 210 which is controlled by the contents managing portion 110 (Step S420).

When digital contents which can be finally provided for CC side are prepared, the digital contents are provided for users who are connecting to use service according to the present invention through a web service (Step S430). In case where there are users to buy digital contents, payment, key management, and information regarding various kinds of items, etc. are managed in connection with the payment gateway (Step S340).

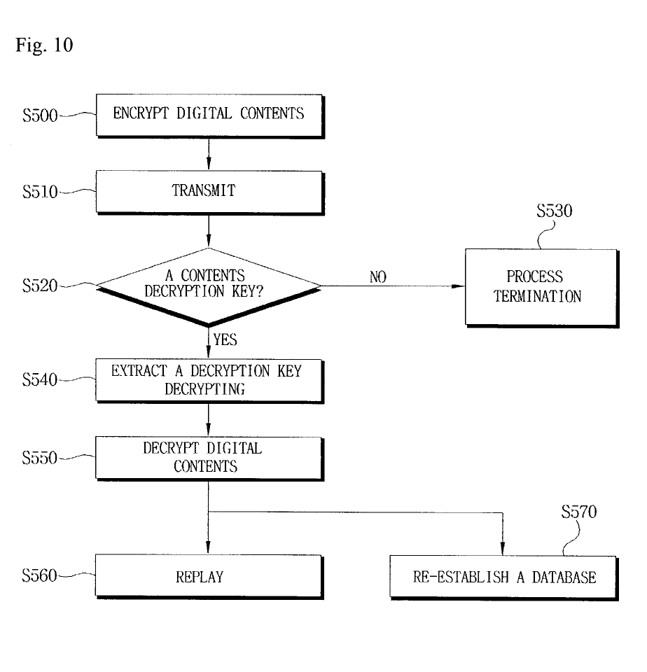

The above process describes a process of storing and managing the entire digital contents provided in CD 20 without request of CC 40 side in database 210 of contents managing portion 110, and the above process may be performed on request of CC 40, when necessary. After preparation of digital contents to be provided for CD side is finished as described above, a process of using the above digital contents by means of a unique key at CC side is explained referring to FIG. 10.

In case where there is a request for particular digital contents from a user CC (consumer), CD encrypts the digital contents that the consumer requested, for example, mp3 file of a music file with the key (CD_UUID) of encrypting the corresponding digital contents (Step S500). The encrypted mp3 file is transmitted through Internet on request of a consumer (Step S510).

A decryption process should be performed, in order that the contents consumer plays the encrypted mp3 file. At this time, a contents decryption key for using the contents is necessary wherein a key necessary for decryption is provided after being encrypted with a unique system ID (CC_UUID) of the corresponding contents consumer mentioned above. In other words, a mp3 file decryption key that is encrypted with the unique key (CC_UUID) of a consumer is provided.

Hence, it is important whether the encrypted decryption key transmitted along with the encrypted contents can be decrypted, thereby decrypting contents, so that the corresponding digital contents are transferred to a consumer to use the corresponding contents. That is, a key for decrypting contents is necessary for using contents wherein the decryption key also is transmitted to users after being encrypted and thus a process of decrypting the key must be first proceeded.

It could be said that a key capable of decrypting an encrypted contents decryption key is extracted from the system information of a user. In other words, since a consumer who buys contents first encrypts a contents decryption key with a unique key (a key generated from the system information; CC_UUID) generated in registering a user, for a further decryption of the contents decryption key it must be checked whether CC_UUID generated from the system information of the consumer is identical to key which encrypts a contents decryption key. In case where the above check result is identical, the contents decryption key can be decrypted (Step S520). If a key capable of decrypting the encrypted mp3 file decryption key is not identical to the unique key of the consumer in the above check result, an operation is terminated along with a message noticing that the corresponding consumer is not an authorized user (Step S530).

However, in case where a key capable of decrypting the encrypted mp3 decryption key is identical to CC_UUID, the extracted user personal unique ID, the encrypted mp3 decryption key is decrypted by the system ID of a consumer, CC_UUID and thus extracting the contents decryption key (Step S540). The mp3 file is decrypted using the above extracted contents decryption key (Step S550). The decrypted file generates digital contents using an exclusive viewer (Step S550).

Further, music DB (hereinafter “MDB) of managing the above music information is made in the computer of CC in order to manage information regarding all the music which are bought by CC. CC also updates its own MDB whenever CC listens to a new music. Whenever a program for CC is executed to listen to music, MDB is first examined. As a result of examination, in case of a new music, its information such as CCI, MCN, etc. is recorded in the music database file, in case of the existing music, it examines whether CCI, MCN, etc. which is recorded in the music database file is identical to CCI, MCN, etc. of music to be played. If not identical, its operation is discontinued. Since CC_UUID of CC is stored as encrypted by the SysCrypt, the secret key CD_UUID of music that is decrypted using CC_UUID maintains its confidentiality. In the explanation relating to the above FIG. 10, although a music file is exemplified as digital contents, various contents including music contents may be all applied.

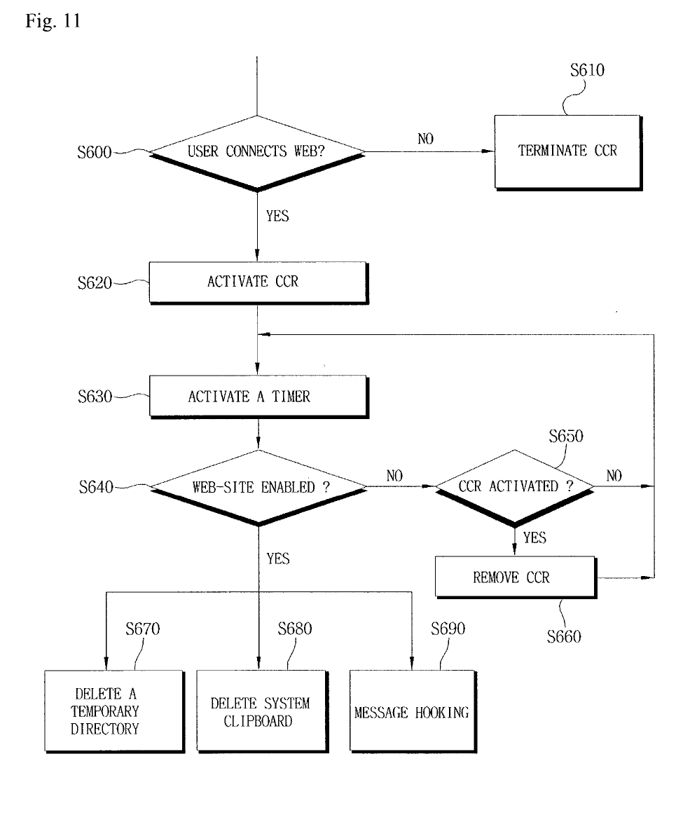

Next, the architecture and operation of the contents controlling portion (CCR) which is mentioned in the overall arch as in FIG. 1 are explained referring to FIG. 11.

The contents controller 50 performs its operation when CC visits a homepage provided by the system according to the present invention and reads contents in a distribution process of contents which are provided, managed, and used by CPM. The homepage and function of keyboard, mouse, etc. are restricted by CCR in the user system. For example, when CC connects to an on-line education site and reads education-related contents provided by this site, a contents provider prevents CC from copying the education contents or storing them in the computer of CC or outputting them as a print or capturing the screen, while enabling CC only to read the education contents. Such is to prevent CCs from using or outputting contents without permission through a process of the correct purchase or use. This will be in detail explained by means of FIG. 11.

First, a user connects to a homepage provided by CD through a web browser. Simultaneously with the opening of the homepage, CCR provided in the present invention is performed and thus controlling a general operation. In other words, when a user CC connects to a homepage, CPM starts CCR automatically (Step S600). Also, when a user moves homepage to other site, CCR is terminated.

While CCR is started, a timer is started (Step S610). The role of the timer checks whether a window displaying the corresponding homepage is enabled on a terminal (monitor, etc.) of CC while operating during the activation of a homepage (Step S620). In other words, it checks whether a window which includes contents to be protected as provided by CD is an activated window (i.e., a window which is displayed front on a monitor and whose type tool bar is blue).

In case where CC does not see a window which includes contents, it is checked whether CCR is activated or not (Step S620). If activated, CCR is killed (Step S640). If not, it goes back to the first process of checking whether window is activated while a timer is operated and thus the above operation is repeatedly performed. That is, in case where a window indicating service according to the present invention in several windows on a monitor is activated, i.e., Active Window=Main Window, the function of CCR is performed.

The most function performed in CCR is executed using the function of a window hooking. Briefly speaking, the hooking strongly intercepts and changes window procedure of all the processes. In other words, it penetrates space of other process than the space of its own process and thus freely changing it.

When function of CCR is performed as a result of the above decision, clipboard control and temporary directory deletion functions are performed by an internal timer. Such two processes is repeatedly performed by an internal timer every regular interval. When an event occurs by a keyboard typing or a pointing device such as mouse by CC, a message hooking is executed. A keyboard hooking, mouse hooking, window hooking, etc. belong to the message hooking. The functions of storage, copy, and screen capture by a keyboard input are controlled by means of a keyboard hooking and functions of storage, copy, and html source viewing are likewise controlled by means of a mouse hooking.

In relation with the above mentioned examples, a temporary directory deletion function indicates that in case of executing a kind of web browser, Internet Explorer of Microsoft, a temporary directory is generated for a fast display of data which are displayed on a monitor by Explorer and are provided on the corresponding web site when connecting to a particular web site in a user's computer when repeatedly used and data which are displayed are automatically downloaded in the directory. In other words, a variety of data provided by CC are automatically stored in a user's computer. Hence, the function of the present CCR periodically deletes content of a temporary directory generated above and thus prevents digital contents from being stored in a user's computer without permission, thereby protecting digital contents. Since these directories are generated on a regular rule by operating system used, it can be seen that the corresponding temporary directory exists by examining the rule of an operating system.

Further, a system clipboard of a computer can copy the content displayed on the present screen using a PrtSc key of a computer. Thus, in case where image information whose copyright is held by CD is displayed on screen, a user can copy it in a system clipboard using a PrtSc key and edit it later for further use. Hence, deleting contents stored in a system clipboard in order to prevent the above illegal duplication can protect digital contents.

In relation with the message hooking, all the commands are completed by transferring a message in a windows operating system. Message generated by a user is stored in a message queue of windows and windows accesses to the message queue and reads the message and performs the command. Therefore, during the operation of CCR the message inputted by a user for protection of digital contents is hooked and it is checked if these messages include a particular message (e.g., data copy, etc.). As a result, if a particular message is included in the messages, the message is deleted from the message queue and the remaining messages are processed in the windows, thereby barring commands made without permission of CD.

CC is under the first restriction in reading and using contents on homepage provided in the system according to the present invention due to the above functions performed by CCR. The first restriction provides some inconvenience since CC side is under the first restriction in performing functions on browser, whereas the first restriction is a first certain solution that CD side can securely open and provide a good quality of contents. And a secondary management of protecting, distributing, and distributing contents themselves may be proceeded by CPM as mentioned above.

As described above, CMS, a system for protecting and managing contents provided in the present invention may be provided being moduled so that service through a integrated connection with the existing DRM function+watermarking+authentication and mobile agent, etc. and interface by each part are possible. CMS minimizes role of a server and a client and is a system of a specialized form in CD (or CP). CMS can manage all things in the server of CD.

At present under the condition that a contents owner is reluctant to entrust his own contents to another person for management, as in the case of Korea and Japan, the system provided in the present invention can manage contents, a user key, and a contents encryption key in the server of CD and thus flexibility of performance is furnished. Further, the key managing portion 130 manage a user's payment history and a user's information, whereby CD can utilize them in an advertising and public relation and proceed an advertising using a watermarking technology.

The system of the present invention minimizes (4˜5M) capacity of program (viewer) of a general user and thus reducing a downloading time and pursuing convenience, and also it is possible to optimize a model which can be available in the restricted capacity of a mobile device like a mobile phone. In other words, the system is devised flexibly to be considered from the time of its design for suitable to a mobile device application such as reduction in a viewer size and implementation with JAVA so that it can be applied to the screen of a mobile phone. In particular, the system suggested in the present invention can be manufactured using a JAVA application. In this regard, if the above suggested function is implemented by being loaded on a chip, implementation of its interface is just required.

The present invention is described in terms of audio contents representing mp3 as an example of digital contents. ‘Digital contents’ indicate various contents such as image, audio, moving picture, e-Book contents, digital education-related contents, broadcasting contents, etc.

Contents may be distributed using an on-line path through a wire and wireless communication. However, they may be distributed using a direct transfer path on off-line, if necessary. A provision and purchase of contents which are carried out on-line and a downloading of program and contents which is also carried out on-line are mainly explained in the above invention. However, as occasion demands, the above digital contents may be distributed off-line after being stored through a storage medium such as floppy disk, CD (compact disc), DVD ROM, laser disk, etc. In case where contents are distributed off-line, when CC initially opens or uses contents in a terminal like its own computer, CC_UUID can be certainly generated by executing a CPM user program and determine if the contents will be used by the generated ID to be controlled.

In addition, it is possible to implement CTS provided in the above present invention so as to be extended to a management system which can be applied to general electric home appliances. At present, general electric home appliances also have a tendency to be digitalized. A digital concept of electric home appliances such as digital TV, digital camera, Internet refrigerator, and Internet washing machine, etc. is emerged. Under such circumstances, it is to make clear CTS provided in the present invention can be applied to a digital electric home appliance and thus widely applied to all the digital electric home appliances which receive and transmit contents.

As described above, a method of protecting and managing digital contents and a system for using the same according to the present invention is an integrated system which protects and manages contents through the entire process from generation of digital contents to distribution thereof. The effects according to the operation of the system are as follows:

First, it is easily connected and applied to a previously built system and thus enabling its utilization. The existing DRM (Digital Rights Management) system generally has a complicated management structure in terms of the architecture of a system and thus it is not easy for a general CP manufacturer to introduce and perform the DRM system. CPM provided in the present invention was designed for applying to any systems without any burden. Particularly, its simple architecture has advantage in terms of speed of the system and thus it is possible to easily apply to a mobile device. In the future, it is very easy in applying to protecting and managing the mobile contents.

Next, while the present system itself is not complicated, the performance itself provides an exact and specialized function. First, in the existing DRM structure, the raw contents which were decrypted had a problem that it was possible for an illegal user to catch the raw contents by a method and device and thus reprocessing and distributing them. However, in the present invention, the raw contents that are decrypted automatically make information of a copyright holder embedded as a watermark when first generating contents. Hence, the information regarding copyright always remains in the contents that are decrypted, thereby protecting the copyright.

Most of digital contents distributed at present are exposed to illegal duplication and distribution and thus infringe to copyright, and is a cause to impede the healthy development of electronic commerce. Under such circumstances, the performance of the present invention makes a contents manufacturer possible to protect ownership and copyright of the contents and guarantees the contents manufactured by himself so as to be distributed and used under the correct distribution system. Such is a ground for accelerating a good quality of contents manufacture. A contents distributor (it could be identical to the above contents manufacturer) constructs and operates a system for protecting and managing contents according to the present invention and thus can be sure to be guaranteed to righteous income by a contents distribution.

In a contents consumer (user) position, it is possible to use a good quality of contents through a reliable service. To be brief, the performance of the present invention makes copyright of a holder of digital contents fundamentally protected, and contents prevented from being used illegally, thereby guaranteeing confidence between traders (a contents manufacturer, a distributor, a user). Such is to further contribute to improvement of a good quality of the digital contents based on confidence, and is to accelerate development of electronic commerce and suggest a new business model.

Until now, the present invention is illustrated and described in examples. However, it is obvious to a person skilled in the pertinent technical field that such embodiments are merely for examples, which are not restricted thereto, and various modifications and conversion are possible within the scope of the technical idea of the present invention. Accordingly, the technical scope of the present invention shall be limited solely by the scope of the claims appended hereto not by the contents described in the embodiments.

What is claimed is:

1. A method of protecting digital contents, comprising the steps of:
(a) receiving encrypted digital contents and a encrypted decryption key which is capable of decrypting said encrypted digital contents;
(b) generating a key from system information which represents personal unique system characteristic that a user uses so as to decrypt said encrypted decryption key; and
(c) decrypting said encrypted contents decryption key using said generated key and decrypting said encrypted digital contents to use.

2. The method of protecting digital contents according to claim 1, further comprising registering system information which represents said personal unique system characteristic and a user unique key which is generated based on the system information in a system which provides said digital contents, before said user receives said digital contents.

3. The method of protecting digital contents according to claim 2, wherein said received digital contents are provided in state encrypted by a contents encrypting key and said contents decryption key is provided in an encrypted state by said user unique key, and said step (c) comprises:
decrypting said encrypted decryption key; and
decrypting said digital contents to use, using said decrypted and extracted decryption key.

4. The method of protecting digital contents according to claim 3, wherein said digital contents are adapted to embed an information signal related to said contents therein as a watermark.

5. The method of protecting digital contents according to claim 4, wherein said received digital contents are stored in a digital contents management tool within said user system.

6. The method of protecting digital contents according to claim 5, wherein said system information is generated based on at least one of unique ID of a processor, information as to a hard disk, ID of a network card, and ID of a system board that are a unique information capable of discriminating said system.

7. The method of protecting digital contents according to claim 6, wherein said system information is generated and checked whenever said received digital contents are used.

8. The method of protecting digital contents according to claim 4, wherein said received digital contents experience the steps of:
(a) embedding a watermark for marking copyright into said digital contents;
(b) embedding header information into said digital contents after embedding the watermark;
(c) encrypting said digital contents in accordance with an encryption key, said encrypted key being generated for encrypting said corresponding digital contents after embedding said header information; and
(d) embedding auxiliary information after said encrypting,
wherein said header information includes at least one of IDs as to copy control information, maximum copy number, intellectual property information, contents consisting of said digital contents, and said additional information includes a bibliographical items as to said digital contents.

9. The method of protecting digital contents according to claim 8, further comprising compressing the corresponding digital contents after embedding said watermark.

10. A system for protecting and managing digital contents, comprising:
digital contents managing means for establishing a database with digital contents to manage;
an encryption key generating means for generating a digital contents encryption key for encrypting digital contents in response to a transmission request of a user system;
a key managing means for storing and managing a user unique key generated using said contents encryption key and system unique information as to a user system to which said digital contents are transmitted;
contents encrypting means for encrypting said digital contents to be transmitted using said digital contents encryption key and said user unique key; and
contents providing means for controlling said key managing means in accordance with said transmission request of a user system, thereby transmitting said digital contents which are encrypted by said contents encrypting means to said user system.

11. The system for protecting and managing digital contents according to claim 10, wherein said contents encrypting means perform encryption of said digital contents, which are provided by said digital contents managing means in response to transmission request of a user system, and encrypt said digital contents by said user unique key, which is provided by said key managing means as a key for decrypting said encrypted digital contents.

12. The system for protecting and managing digital contents according to claim 11, wherein said user system to which said digital contents are transmitted comprises a user unique key generating means using system unique information, wherein said user unique key generating means generate a unique data which is capable of specifying said user system using characteristic information extracted from said user system.

13. The system for protecting and managing digital contents according to claim 12, wherein said user unique key is generated based on at least one of unique ID of a processor, information as to a hard disk, ID of a network card, and ID of system board that are unique information capable of discriminating said user system.

14. The system for protecting and managing digital contents according to claim 13, wherein said user unique key is not registered in a registry of said user system for the purpose of maintaining confidentiality.

15. The system for protecting and managing digital contents according to claim 10, further comprising:
decrypting means for decrypting said digital contents which are transmitted from said contents providing means; and
using means for using said decrypted digital contents.

16. The system for protecting and managing digital contents according to claim 15, wherein said decrypting means comprise:
comparing means for determining whether said user unique key with which said decryption key is encrypted agrees with system information which is used to generate said user unique key by said user system, said decryption key being capable of decrypting said encrypted transmitted digital contents; and
means for extracting said decryption key which is capable of decrypting said digital contents to use in case where said comparing result agrees, and informing that authority is not issued to use said transmitted digital contents in case where said comparing result does not agree.

17. The system for protecting and managing digital contents according to claim 16, further comprising a database establishing and managing means in order to manage said digital contents extracted using said decryption key.

18. The system for protecting and managing digital contents according to claim 10, further comprising digital contents protecting means for protecting said digital contents, which are displayed on a terminal or browser of a user system.

19. The system for protecting and managing digital contents according to claim 18, wherein said digital contents protecting means use windows hooking function, and delete stored contents by checking a system clipboard repeatedly at a predetermined interval, using a timer which is provided in inside of said user system.

20. The system for protecting and managing digital contents according to claim 18, wherein said digital contents protecting means use windows hooking function, and delete a data which is displayed and downloaded in a specific temporary directory.

21. The system for protecting and managing digital contents according to claim 18, wherein said digital contents protecting means perform message hooking at occurrence of an event which occurs by a keyboard or a mouse, and delete the corresponding message from said message queue at occurrence of a message related to copying or printing said digital contents of messages which are inputted in a message queue.
